(19) United States
(12) Patent Application Publication
(10) Pub. No.: US 2007/0085727 A1
(43) Pub. Date: Apr. 19, 2007

(54) Methods and systems for leakage cancellation in radar equipped munitions

(75) Inventors: Glen B. Backes, Maple Grove, MN (US); Steven H. Thomas, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/253,928

(22) Filed: Oct. 19, 2005

(51) Int. Cl. G01S 13/08

(52) U.S. Cl. 342/68; 342/198

(57) ABSTRACT

A radar sensor configured to control detonation of a munition is described that includes a radar transmitter comprising a radar transmit antenna, a radar receiver comprising a radar receive antenna, and a leakage cancellation unit. The leakage cancellation unit is configured to cancel effects of an antenna leakage signal transmitted by the radar transmit antenna and received by the radar receive antenna. To cancel the effects of the leakage signal, the leakage cancellation unit is configured to provide a signal to the radar receiver that is substantially out of phase with the leakage signal received by the radar receiver.

### BACKGROUND OF THE INVENTION

This invention relates generally to controlling detonation of weapons, and more specifically, to methods and systems for controlling a height, or altitude, of munition detonation.

Conventional munitions dropped or launched from aircraft is either released with a high accuracy, or in large numbers, in order to effectively destroy a desired target. To achieve a high accuracy, it is frequently necessary to drop such munitions from an undesirably low altitude. However, dropping conventional munitions from a low altitude exposes the aircraft and crew to air defenses, for example, anti-aircraft artillery and surface-to-air missiles since. Alternatively, to deliver munitions in high numbers, it is frequently necessary to fly an undesirably large number of missions which is expensive, time consuming, and exposes more aircraft and crew to air defenses.

To overcome these problems, smart munitions have been developed. Some smart munitions utilize a guidance and flight control system to accurately maneuver the munition to the desired target. The guidance system provides a control signal to control surfaces of the munition based upon the present position of the munition and the position of the target, so that the control surfaces cause the munition to maneuver toward the target. Such guidance systems typically utilize technologies such as laser guidance, infrared guidance, radar guidance, and/or satellite (GPS) guidance. However these systems are typically related to guiding the munition to a desired location, and are not typically related to detonation of the munition. Furthermore, such guidance systems are expensive and cannot affordably be incorporated into smaller munitions.

Ensuring that launched or dropped munitions detonate (e.g., explode) at the proper time and altitude is critical to success of a mission. Munitions meant for an underground target that detonate before penetrating the ground are less likely to destroy an intended target, and more likely to destroy or cause damage to unintended targets. Munitions that detonate at less than an intended detonation altitude is not likely to inflict the intended widespread, and possibly limited, damage. Rather, such a detonation is likely to result in severe damage to a smaller area. A detonation altitude is sometimes referred to as a height of burst.

### BRIEF SUMMARY OF THE INVENTION

In one aspect, a radar sensor configured to control detonation of a munition is provided. The radar sensor comprises a radar transmitter comprising a radar transmit antenna, a radar receiver comprising a radar receive antenna, and a leakage cancellation unit. The leakage cancellation unit is configured to cancel effects of an antenna leakage signal transmitted by the radar transmit antenna and received by the radar receive antenna. The leakage cancellation unit provides a signal to the radar receiver that is substantially out of phase with the leakage signal received by the radar receiver.

In another aspect, a method which allows tracking of altitude to ground level with a radar sensor is provided. The method comprises providing a signal to be transmitted by the radar sensor as a transmitted signal, generating a leakage cancellation signal that is out of phase with the transmitted signal, and receiving, at the radar sensor, an antenna leakage signal based on the transmitted signal. This method further comprises adding the antenna leakage signal to the leakage cancellation signal, effectively canceling the antenna leakage signal and processing a ground return signal based on the transmitted signal.

In still another aspect, a leakage cancellation unit configured to cancel effects of an antenna leakage signal transmitted by a radar transmit antenna and received by a radar receive antenna is provided. The leakage cancellation unit comprises a circuit that provides a signal to the radar receiver that is substantially out of phase with the antenna leakage signal received by the radar receiver.

### BRIEF DESCRIPTION OF THE DRAWINGS

FIG. 1 illustrates various missions for a munition each of which incorporates a different detonation height for the munition.

FIG. 2 is a block diagram of a radar unit for controlling a height at which the munition detonates.

FIG. 3 is a diagram illustrating a ground return signal and a leakage signal with respect to transmit and receive antennas.

FIG. 4 is a table illustrating attenuation of an antenna leakage signal as a function of transmit and receive antenna separation.

FIG. 5 is a table illustrating attenuation of an antenna leakage signal as a function of transmit and receive antenna separation for a radar sensor which incorporates leakage cancellation.

### DETAILED DESCRIPTION OF THE INVENTION

A small, low cost, detonation altitude (e.g., height of burst) radar sensor incorporating a programmable height of burst capability for multi-functional bombs, submunitions, and low cost missile applications is described. The detonation altitude is programmable in that there are different detonation scenarios including above ground detonation, ground level detonation, and even below ground detonation. The radar sensor is incorporated into the munition and includes radar transmit and radar receive antennas that are close in proximity to one another. However, close spacing between the transmit and receive antennas results in an operational problem in known radar systems since a leakage signal between the two antennas typically causes interference with a ground return signal. Such a leakage signal generally interferes with the capability to operate properly at low altitude operation causing either inaccuracies or tracking of the leakage signal rather than the ground return signal.

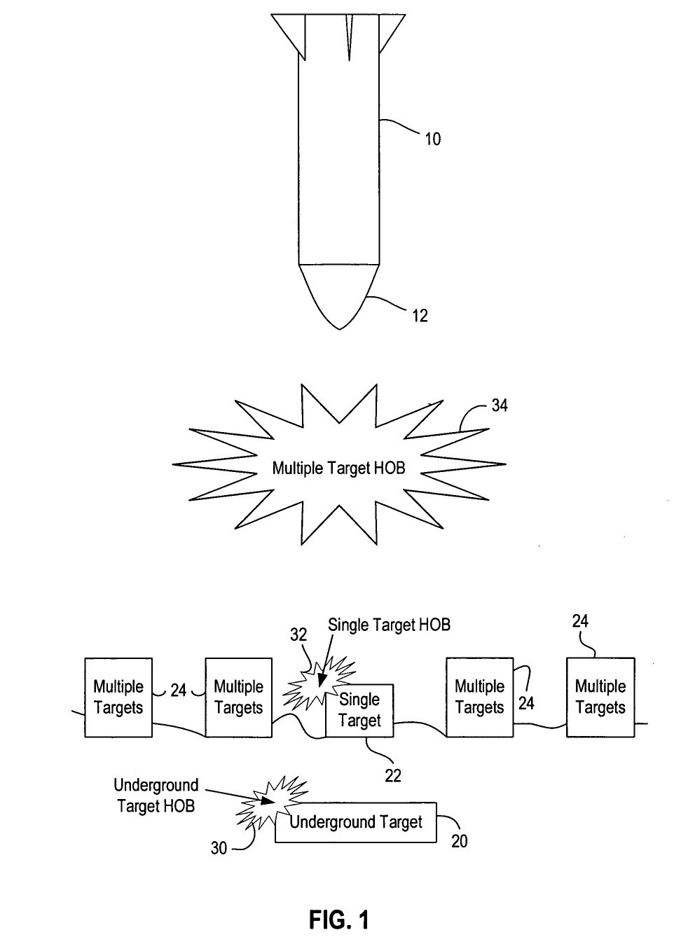

FIG. 1 is a diagram illustrating a munition 10, for example, a bomb or missile, which includes an altitude sensor 12. Altitude sensor 12 is utilized in controlling a height of burst, or detonation altitude, of munition 10. Equipped with altitude sensor 12, munition 10 is configured for use in multiple missions. As illustrated in FIG. 1, munition 10 is configurable for use against an underground target 20, a single ground level target 22, and multiple ground level targets 24.

In one embodiment, munition 10 is configured with a detonation altitude (e.g., a height of burst (HOB)) prior to launch from an aircraft (not shown). The programmed detonation altitude enables detonation at the desired height above (or below) ground level dependent on the particular mission. If munition 10 is to be utilized against underground target 20, it is configured with an underground target detonation altitude (HOB) 30, such that munition 10 will not detonate until a predetermined time has passed after munition 10 is determined to be at a zero altitude. The predetermined time is substantially equal to time that it takes for munition 10 to travel from ground level to a position underground thought to be approximate underground target 20.

Similarly, if munition 10 is to be utilized against a single target 22, it is configured with a single target detonation altitude (HOB) 32, which is approximately the same altitude as single target 22. If munition 10 is to be utilized against multiple targets 24, it is configured with a multiple target detonation altitude (HOB) 34. The multiple target detonation altitude 34 is a detonation altitude above the altitude of the multiple targets 24 which has been determined to be substantially effective against most or all of multiple targets 24.

To carry out the above described multiple missions, sensor 12 has to be capable of detecting an altitude of munition 10 at altitudes at and above zero. In one embodiment, sensor 12 is a radar sensor that is configured to address known problems associated with the spacing between a transmit antenna and a receive antenna within the constraints of small bombs. More specifically, the radar sensor is configured to substantially eliminate the effects of the cross talk (leakage signals) that occurs between radar transmit and receive antennas when spaced closely to one another and operating at lower altitudes.

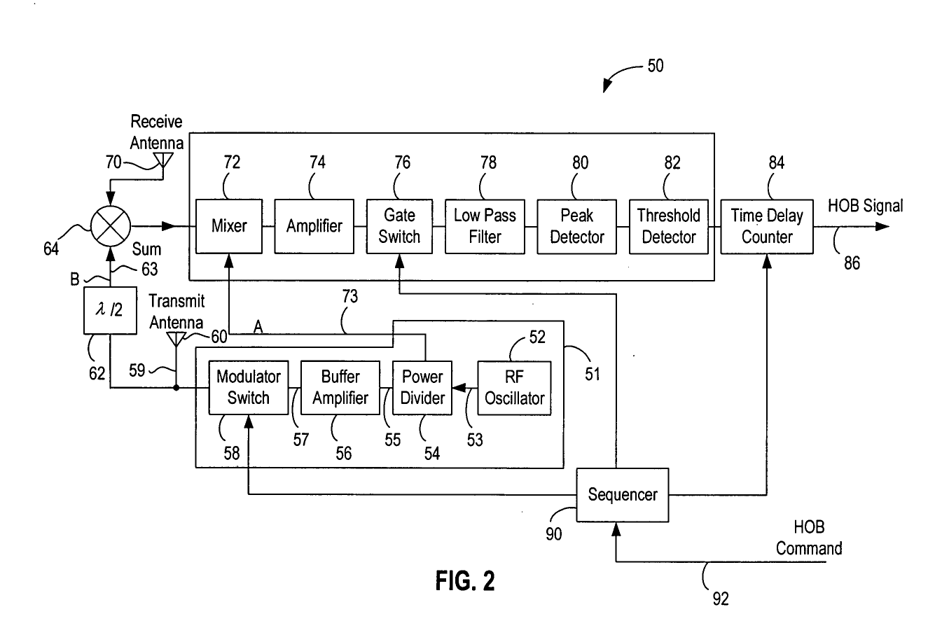

FIG. 2 is a block diagram of an altitude sensor 50 that is utilized for controlling a detonation altitude of a munition, for example, munition 10 (shown in FIG. 1). In the embodiment illustrated, altitude sensor 50 incorporates a radar altimeter and is generally referred to herein as radar sensor 50. A radar transmitter 51 portion of radar sensor 50 includes an RF oscillator 52 that provides a frequency source for transmission and for down conversion of radar return pulses. More specifically, and with respect to transmission, RF oscillator 52 provides an RF frequency signal 53 to a power divider 54. Power divider 54 outputs a RF signal 55 to buffer amplifier 56, which outputs an amplified RF signal 57 for transmission. The amplified RF signal 57 for transmission is provided to a modulator switch 58, which, depending on a state of modulator switch 58, modulates the amplified RF signal and routes the modulated output signal 59 to transmit antenna 60 for transmission as a radar signal towards the ground.

Modulator switch 58 provides pulse modulation of amplified RF signal 57. Buffer amplifier 56 provides isolation to RF oscillator 52 from impedance variations caused by modulation switch 58. Such isolation reduces oscillator frequency pulling during transmission, to a tolerable level, which allows the radar signal return frequency to remain within a pass band of radar receiver 64. Oscillator load pulling is sometimes caused by load impedance changes present at an output of the oscillator. For example, as the impedance at the oscillator varies, the frequency of the oscillator varies somewhat. Referring to radar sensor 50, modulation switch 58 output impedance varies as the “switch” is opened and closed, which causes load pulling. Such load pulling can cause a problem in a radar if the transmit oscillator is also utilized as the frequency source for receiver down conversion. The difference between the frequency transmitted and the frequency used to down convert the return signal at the mixer, must be low enough such that the down converted return signal with its doppler shift plus any load pulling is within the bounds of the receiver bandwidth.

Modulated output signal 59 is also routed to a phase shifter 62. Phase shifter 62 is configured to shift a phase of modulated output signal, in one embodiment, by approximately 180 degrees. Output from phase shifter 62, phase shifted modulated signal 63 is input to a summing device 64.

Now referring to a radar receiver 68 portion of radar sensor 50, radar signals transmitted utilizing transmit antenna 60 are reflected by the ground and received by receive antenna 70 as radar ground return pulses. Receive antenna 70 passes the received radar return pulses to summing device 64 whose output is input to a mixer 72 within radar receiver 68. By summing the phase shifted modulated signal 63 with signals received at receive antenna 70, leakage signals propagating from transmit antenna 60 to receive antenna 60 are effectively canceled and radar sensor 50 processes only those signals associated with ground returns.

Referring again to FIG. 2, mixer 72 then down converts (demodulates) the non-canceled radar return pulses based upon a signal 73 received from power divider 54 originating from RF oscillator 52. The down conversion provided by mixer 72 results in a Doppler frequency (F_{D}) signal that is proportional to a downward velocity (V) of munition 10. Stated mathematically, F_{D}=2V/λ, where λ is a wavelength of the radar. For example, for a velocity of 400 feet per second, and a radar frequency of 4.3 GHz (a wavelength 0.229 feet), the Doppler frequency is (2)(400)/0.229 or 3493 Hz at an output of mixer 72.

Amplifier 74 amplifies the Doppler frequency signal for further processing, and a gate switch 76 is activated at a time after transmission of the radar signal that is consistent with the preset detonation altitude. In other words, for a detonation altitude of 100 feet, gate switch 76 is configured to “look” for radar return signals at a time substantially equal to the time that it takes the transmitted radar signals to travel 200 feet (from transmit antenna 60 100 feet to ground and back 100 feet to receive antenna 70).

Received radar return signals that pass through gate switch 76 are received by low pass filter 78 which is configured with a filter bandwidth set as low as possible while remaining above a maximum expected Doppler frequency. Setting such a bandwidth for low pass filter 78 allows effective integration of as many radar return pulses as possible, thus maximizing sensitivity of radar receiver 68, while allowing for relatively low power transmissions from transmit antenna 60. A filtered radar return output from low pass filter 78 is peak detected utilizing peak detector 80 which results in a DC level signal that is input into threshold detector 82 and subsequently to time delay counter 84 which outputs a detonation signal 86.

A sequencer 90 controls operation of radar sensor 50 based on detonation altitude commands 92 received by sequencer 90 from an external system, for example, programming instructions received before munition 10 is launched or dropped from an aircraft. Sequencer 90 provides signals to modulation switch 58, gate switch 76, and time delay counter 84. More specifically, when a radar return time delay (due to altitude of munition 10) is equal to a gate delay at gate switch 76, as set by programmed sequencer 90, the signals representative of the radar return pulses are passed through gate switch 76 to threshold detector 82. Programmable sequencer 90 provides a capability to program a desired detonation altitude (or gate time delay) for munition 10 prior to launch.

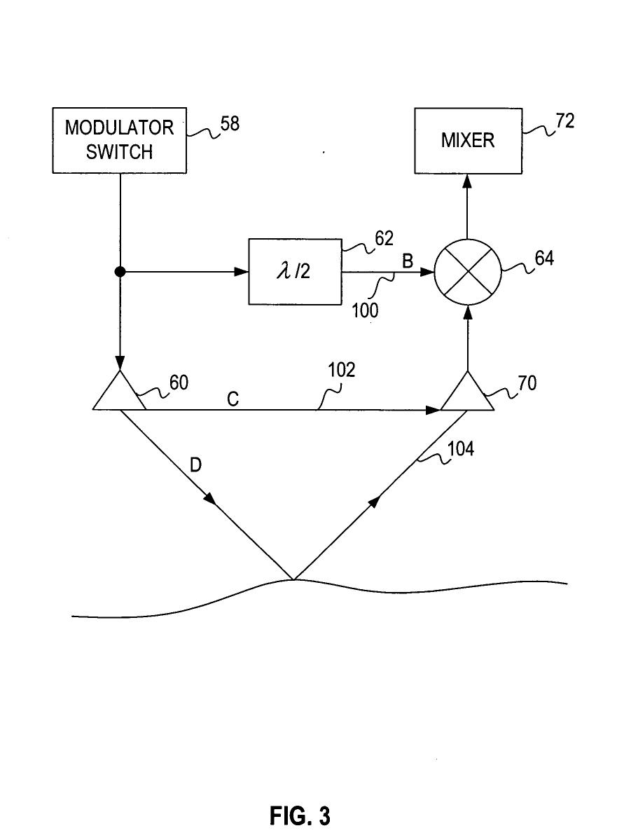

FIG. 3 is a block diagram further illustrating operation of phase shifter 62 and summing device 64 with respect to antenna leakage signals and radar ground return signals. Specifically, incorporation of phase shifter 62 and summing device 64 provides a cancellation scheme that includes a cancellation pulse signal 100 that is 180 degrees out of phase with antenna leakage signal 102. Cancellation pulse signal 100 effectively cancels the effect of antenna leakage signal 102 on ground return signal 104. Effective cancellation of antenna leakage signal 102 allows radar sensor 50 (shown in FIG. 2) to track ground return signals 104 to ground level thereby providing for accurate munition detonation altitudes in low altitude regions.

A strength of antenna leakage signal 102 is a function of the separation distance between transmit antenna 60 and receive antenna 70. On a small submunition, there is not sufficient room for the antennas 60 and 70 to be substantially separated. Therefore, transmit antenna 60 and receive antenna 70 are located in close proximity to one another and the strength of leakage signal 102 can be quite large compared to a strength of ground return signal 104.

Cancellation pulse signal 100 is also noted as equation B in FIG. 3 and antenna leakage signal 102 is also noted as equation C. In one embodiment, the respective signals are described according to:

$$B = \frac{2 τ}{d} + {\sum }_{n = 1}^{∞} \frac{2}{n π} sin \frac{n πτ}{d} sin ( {ω}_{O} t + {ϕ}_{O} + λ / 2 )$$

$$C = \frac{2 τ}{d} + {\sum }_{n = 1}^{∞} \frac{2}{n π} sin \frac{n πτ}{d} sin ( {ω}_{O} t + {ϕ}_{O} )$$

The 180 degree phase shift in cancellation pulse signal 100 is used to cancel effects of leakage signal 102 between transmit antenna 60 and receive antenna 70 before those effects are routed to mixer 72. In the embodiment, ground return signal 104 is defined as

$$D = \frac{2 τ}{d} + {\sum }_{n = 1}^{∞} \frac{2}{n π} sin \frac{n πτ}{d} [ sin ( {ω}_{o} + {ω}_{d} ) t - 2 {ω}_{o} \frac{{R}_{o}}{c} - {ω}_{d} + {ϕ}_{o} ) ] .$$

In the embodiment, λ/2=π and sin(ωₒt=λ/2)=sin(ωₒt+π)=−sin(ωₒt). Adding equation B to equation C provides a result of zero and the effects of leakage signal 102 are attenuated due to the cancellation provided by cancellation pulse signal 100. In an embodiment, not only is the phase shift between the two signals 180 degrees, but also the amplitude is equivalent. In one embodiment, summing device 64 includes a variable resistor network such that amplitudes of leakage signal 102 and cancellation pulse signal 100 may be balanced.

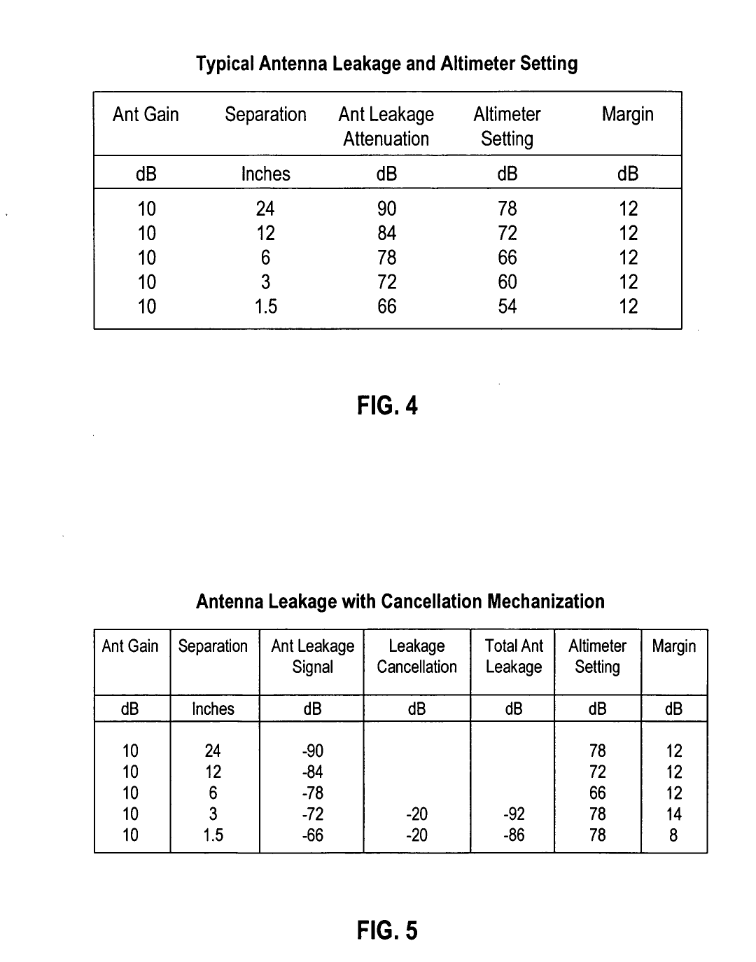

FIG. 4 is a table 150 illustrating attenuation of antenna leakage signal 102 as a function of transmit and receive antenna separation, from 24 inches of separation to 1.5 inches of separation for a radar sensor which does not incorporate the above described leakage cancellation. At 1.5 inches of separation, the antenna leakage is only attenuated by 66 dB or less. The track threshold of one embodiment of radar sensor 50 is shown in FIG. 4 as an altimeter setting. A programmable sensitivity threshold setting is adjusted at low altitudes (i.e. where the leakage signal is present in the time domain) so that the antenna leakage signal will not interfere with the ground return signal. The problem is that as the programmable sensitivity threshold is set lower because of the antenna leakage signal strength, then the ground return signal strength may not be sufficient to track.

FIG. 5 is a table 200 illustrating attenuation of antenna leakage signal 102 as a function of transmit and receive antenna separation, from 24 inches of separation to 1.5 inches of separation for a radar sensor which incorporates the above described leakage cancellation. With the implementation of the leakage cancellation signal 100 (shown in FIG. 3), leakage signal 102 is effectively reduced or cancelled such that the programmable sensitivity threshold of radar sensor 50 can be set higher and ground return signals 104 can be increased through amplification. In the embodiment illustrated in FIGS. 3 and 5, leakage cancellation signal 100 results in an additional 20 dB lower leakage signal. Therefore, the altimeter setting (e.g., programmable sensitivity threshold of radar sensor 50) can be adjusted higher to allow tracking of ground return signal 104. In alternative embodiments, adequate margins are maintained in radar sensor 50 to account for variations in system gain due to ground reflectivity, roll and pitch, and environmental effects.

The pulse modulated signal of ground return signal 104 (defined by equation D) above, has both a frequency shift due to the Doppler effect and a phase shift due to both range and the Doppler effect. The phase shift due to range is much more dominate than the phase shift due to the Doppler effect. When ground return signal 104 is mixed with the signal from power divider 54 (shown in FIG. 2) and defined as signal A, where, the fundamental frequency (i.e. ωₒ) is removed and the remaining signal represents the combination of the Doppler frequency and the pulse modulation spectrum ((i.e. each spectral line that is separated by the duty cycle). Low pass Doppler filter 78 (shown in FIG. 1) only allows the Doppler frequency spectrum to pass and be processed whereby velocity can then be determined and used to estimate the detonation altitude.

The methods and systems described herein provide a solution to the problems associated with antenna leakage in small, low cost radar sensors. Such radar sensors are therefore capable of providing signals that result in a munition detonating at a programmed detonation altitude. The detonation altitude, as described above, is sometimes referred to as a height of burst. Examples of such munitions include multi-functional bombs, submunitions, and low cost missiles. The detonation altitude is programmable to include above ground detonation at a programmed altitude, ground level detonation, and below ground detonation. The radar sensor is incorporated into the munition and includes radar transmit and radar receive antennas that are close in proximity to one another. However, the problems known to exist with close spacing between the transmit and receive antennas are addressed utilizing the antenna leakage signal cancellation embodiments described above. These embodiments reduce or eliminate interference of antenna leakage signals with ground return signals thereby providing a capability to operate properly at low altitudes that are normally associated with a desired height of detonation.

While the invention has been described in terms of various specific embodiments, those skilled in the art will recognize that the invention can be practiced with modification within the spirit and scope of the claims.

What is claimed is:

1. A radar sensor configured to control detonation of a munition, said radar sensor comprising:
a radar transmitter comprising a radar transmit antenna;
a radar receiver comprising a radar receive antenna; and
a leakage cancellation unit configured to cancel effects of an antenna leakage signal transmitted by said radar transmit antenna and received by said radar receive antenna, said leakage cancellation unit configured to provide a signal to said radar receiver that is substantially out of phase with the leakage signal received by said radar receiver.

2. A radar sensor according to claim 1 wherein said leakage cancellation unit comprises:
a phase shifter; and
a summing device.

3. A radar sensor according to claim 2 wherein said radar transmitter comprises a modulator switch, said phase shifter configured to receive an output of said modulator switch.

4. A radar sensor according to claim 3 wherein said phase shifter is configured to shift the output of said modulator switch by approximately 180 degrees.

5. A radar sensor according to claim 2 wherein said radar receiver comprises a mixer, said summing device configured to output to said mixer a sum of an output from said phase shifter and a signal received from said radar receive antenna.

6. A radar sensor according to claim 2 wherein said summing device comprises an amplitude adjustment device configured to adjust an amplitude of the signal input from said phase shifter to be substantially equal with a leakage signal received by said radar receiver.

7. A radar sensor according to claim 6 wherein said amplitude adjustment device comprises a variable resistor network.

8. A method which allows tracking of altitude to ground level with a radar sensor, said method comprising:
providing a signal to be transmitted by the radar sensor as a transmitted signal;
generating a leakage cancellation signal that is out of phase with the transmitted signal;
receiving, at the radar sensor, an antenna leakage signal based on the transmitted signal;
adding the antenna leakage signal to the leakage cancellation signal, effectively canceling the antenna leakage signal; and
processing a ground return signal based on the transmitted signal.

9. A method according to claim 8 wherein generating a leakage cancellation signal comprises generating a signal by shifting a phase of the signal to be transmitted by approximately 180 degrees.

10. A method according to claim 8 wherein generating a leakage cancellation signal comprises generating a signal according to
$$B = \frac{2 τ}{d} + {\sum }_{n = 1}^{∞} \frac{2}{n π} sin \frac{n πτ}{d} sin ( {ω}_{O} t + {ϕ}_{O} + λ / 2 )$$
where the signal to be transmitted is generated according to
$$C = \frac{2 τ}{d} + {\sum }_{n = 1}^{∞} \frac{2}{n π} sin \frac{n πτ}{d} sin ( {ω}_{O} t + {ϕ}_{O} ) .$$

11. A method according to claim 8 wherein adding the antenna leakage signal to the leakage cancellation signal comprises balancing an amplitude of the leakage cancellation signal to that of the antenna leakage signal.

12. A method according to claim 11 wherein balancing an amplitude of the leakage cancellation signal comprises controlling operation of a variable resistor network to adjust the amplitude of the leakage cancellation signal.

13. A leakage cancellation unit configured to cancel effects of an antenna leakage signal transmitted by a radar transmit antenna and received by a radar receive antenna, said leakage cancellation unit comprising a circuit providing a signal to the radar receiver that is substantially out of phase with the antenna leakage signal received by the radar receiver.

14. A leakage cancellation unit according to claim 13 wherein said circuit comprises:
a phase shifting circuit configured to output the signal that is substantially out of phase with the antenna leakage signal; and
a summing circuit configured to add the antenna leakage signal with the output of said phase shifting circuit.

15. A leakage cancellation unit according to claim 14 wherein said phase shifting circuit configured to receive an output of a modulator switch of a radar sensor.

16. A leakage cancellation unit according to claim 14 wherein said phase shifting circuit is configured to shift the phase of a received signal by approximately 180 degrees.

17. A leakage cancellation unit according to claim 14 wherein said summing circuit is configured to output to a mixer of a radar sensor the sum of the output from said phase shifting circuit and a signal received from a receive antenna of a radar sensor.

18. A leakage cancellation unit according to claim 14 wherein said summing circuit comprises an amplitude adjustment device configured to adjust an amplitude of the signal received from said phase shifting circuit such that its amplitude is substantially equal with a received antenna leakage signal.

19. A leakage cancellation unit according to claim 18 wherein said amplitude adjustment device comprises a variable resistor network.
